(19) United States
(12) Patent Application Publication
(10) Pub. No.: US 2026/0350723 A1
(43) Pub. Date: Nov. 5, 2026

(54) Multi-User Collaborative Itinerary Engine with Role-Based Preference Blending

(71) Applicants: Ashton Lightfoot, Atlanta, GA (US); Clinton Brooks, Atlanta, GA (US)

(72) Inventors: Ashton Lightfoot, Atlanta, GA (US); Clinton Brooks, Atlanta, GA (US)

(21) Appl. No.: 19/171,308

(22) Filed: Apr. 6, 2025

(51) Int. Cl. G06Q 50/14

(52) U.S. Cl. CPC G06Q 50/14

(57) ABSTRACT

The present invention provides a method and system for generating a collaborative travel itinerary for a group of users, where each user defines travel preferences based on assigned roles (e.g., foodie, adventurer, relaxer). The system blends these role-based preferences into a unified itinerary that accommodates individual needs while maintaining group balance. Users can collaboratively modify the itinerary in real-time through an editing interface, with changes tracked and conflicts resolved by suggesting alternatives. A conflict resolution engine dynamically adjusts the itinerary based on user feedback, ensuring a personalized and harmonious group experience. By leveraging real-time data and user input, the system continuously improves collaborative planning, ensuring all group members' preferences are met efficiently and transparently.

### FIELD OF THE INVENTION

The present invention relates to the field of travel planning and, more particularly, to a system and method for collaborative itinerary creation in which multiple users, each with their distinct preferences and roles, contribute to and adjust a shared travel plan. The system leverages a role-based preference blending mechanism, wherein users' preferences are automatically weighted based on their roles (e.g., foodie, adventurer, relaxer), resulting in optimized itineraries that balance group satisfaction and personalization.

### BACKGROUND OF THE INVENTION

Traditional travel planning tools focus on individual preferences, without enabling seamless collaboration among multiple users. Existing tools often struggle to integrate multiple participants' preferences efficiently, leading to conflicts and inefficiencies during itinerary creation. This invention solves these issues by providing a collaborative framework that blends user roles and preferences into a unified, balanced itinerary reflecting collective group interests.

### SUMMARY OF THE INVENTION

The invention discloses a method and system for generating a collaborative travel itinerary using a role-based preference blending engine. Multiple users contribute their preferences, which are weighted according to user-defined roles. The system's conflict resolution engine ensures that itinerary selections remain balanced, and a collaborative editing interface provides transparency by tagging and tracking all user modifications. A feedback loop allows for real-time adjustments and voting when conflicts arise.

### BRIEF DESCRIPTION OF THE DRAWINGS

FIG. 1 illustrates the overall architecture of the multi-user collaborative itinerary engine, including modules for individual user inputs, the preference blending engine, conflict normalization, real-time synchronization, feedback looping, and unified itinerary output.

FIG. 2 is a process flow diagram showing the activity addition and real-time update sequence. The figure demonstrates how user suggestions pass through preference checks, blending validation, itinerary updates, and group notifications before generating a shared output.

FIG. 3 is a logic diagram depicting the group conflict-resolution process. It shows how conflicting activity preferences trigger constraint analysis, timing adjustments, fallback alternatives, and automated conflict resolution based on collective priorities.

FIG. 4A is a user-interface component diagram illustrating accountability labels, manual adjustment options, timestamps, and user feedback bars for collaborative transparency.

FIG. 4B is a voting interface diagram showing consensus-driven decision mechanisms, including voting summaries, consensus tags, auto-selection prompts, and user avatar mapping.

FIG. 4C is a continuation of the feedback process diagram, detailing how conflicting activities and suggested alternatives are finalized through the decision module to produce a balanced itinerary.

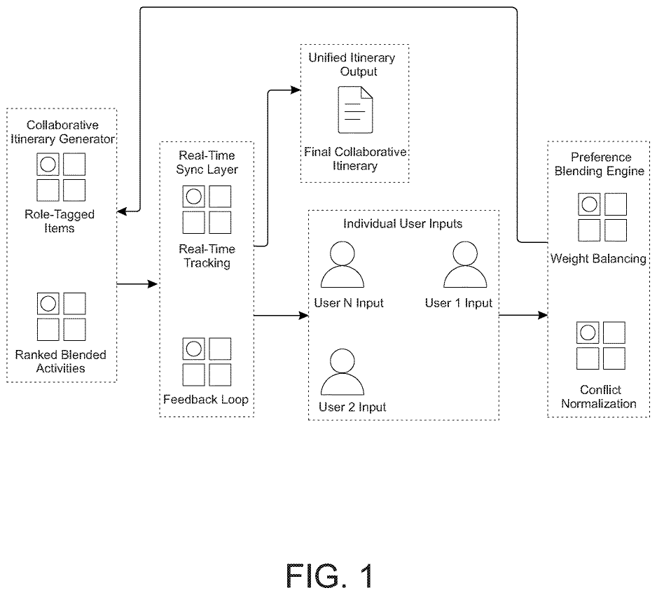

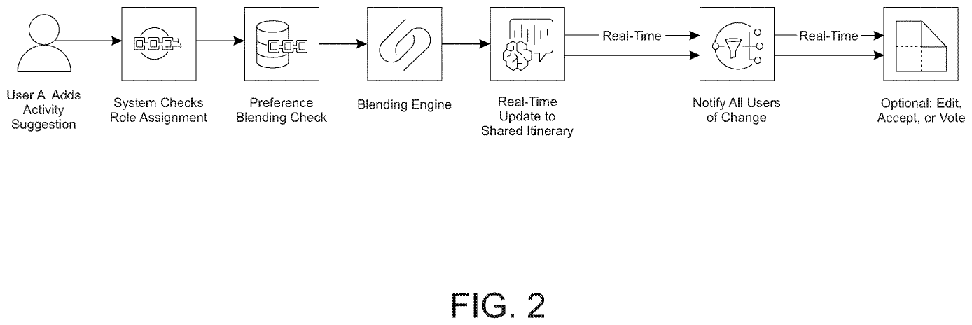

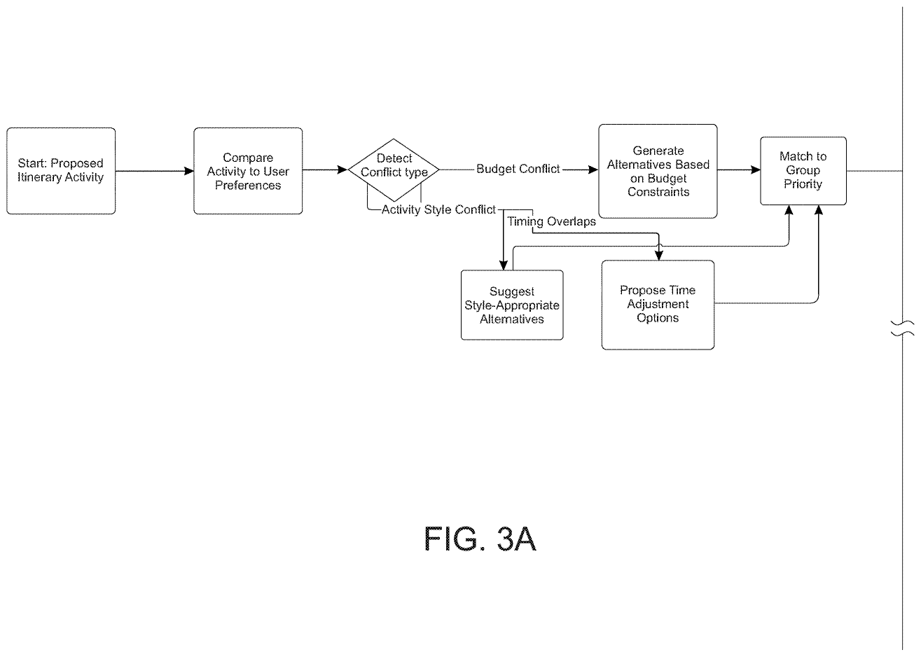

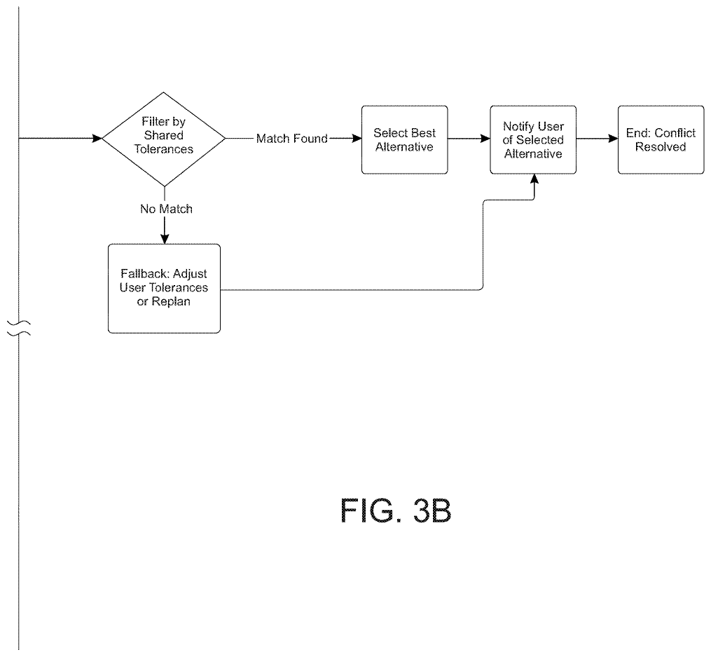

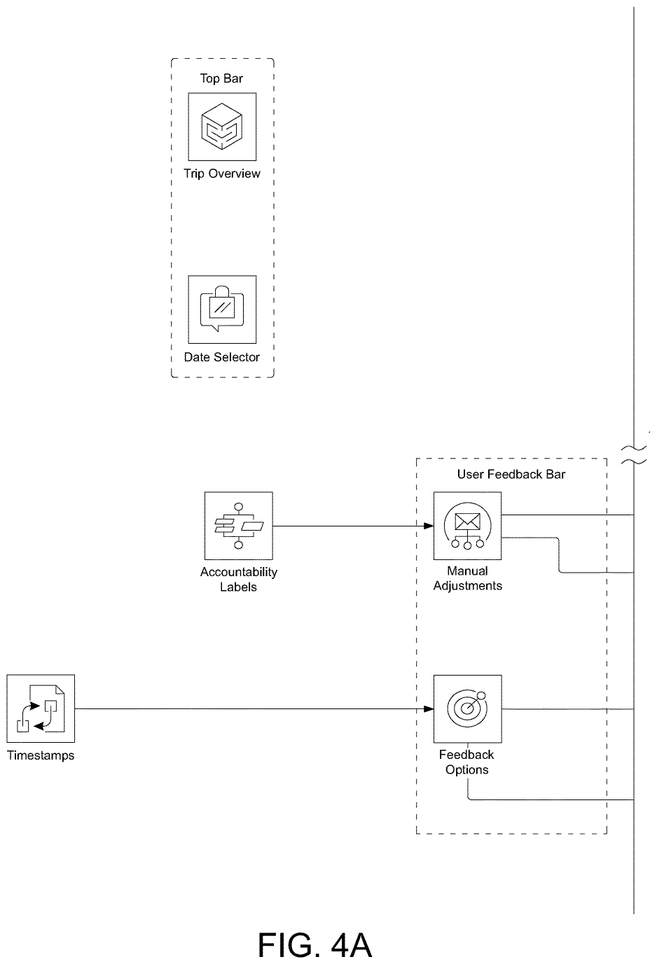

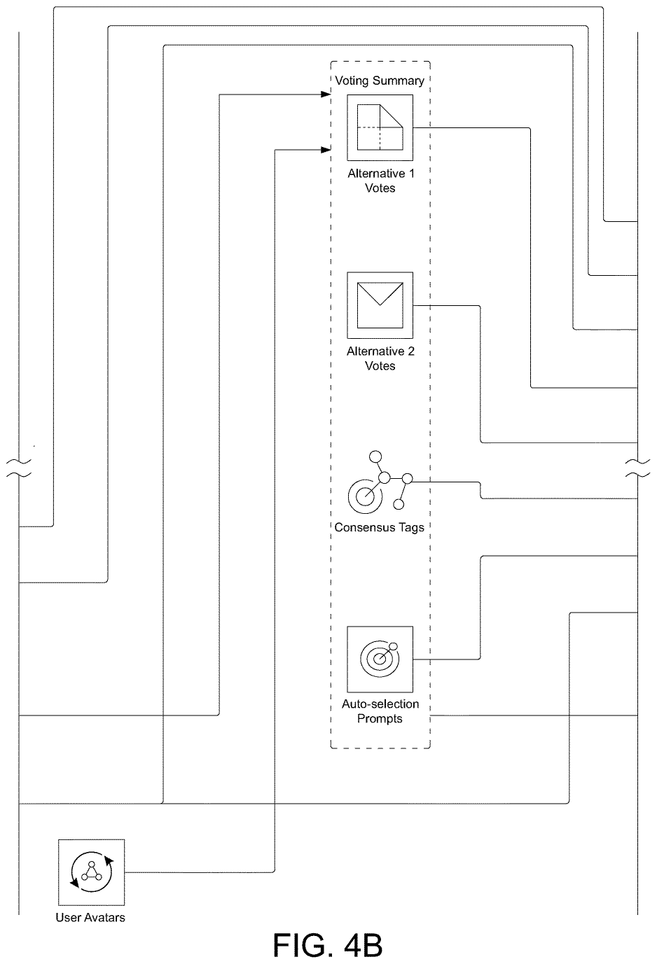

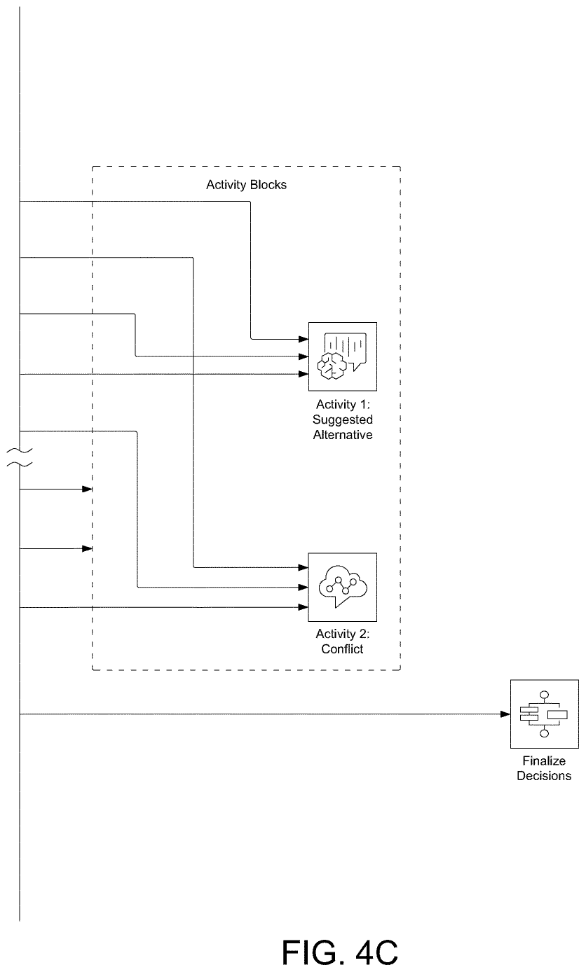

### DETAILED DESCRIPTION OF THE INVENTION

The system comprises the following main components:
1. Role-Based Preference Engine: Each user defines travel preferences, categorized and weighted according to assigned roles. These preferences form the foundation for itinerary generation.
2. Collaborative Editing Interface: A shared interface enables users to co-edit itineraries in real time, displaying tagged changes for accountability and enabling immediate group feedback.
3. Conflict Resolution Module: This component analyzes preference clashes, timing conflicts, or overbooked items, proposing alternate activities or adjustments using a blended AI-driven approach.
4. User Feedback and Adjustment Mechanism: A feedback loop allows users to evaluate itinerary options, indicating satisfaction or proposing edits. The system adapts to user feedback for improved future recommendations.
5. Integration with External Data Sources: The engine connects with APIs such as weather, transportation, and booking services to ensure real-time updates and accurate itinerary feasibility.

### POTENTIAL EMBODIMENTS

The system may be implemented as a web or mobile platform, accessible across multiple devices with synchronization. It may integrate with social media or previous trip data to refine user profiles and streamline collaborative planning for future itineraries.

1. A method for generating a multi-user collaborative travel itinerary, comprising:
(a) receiving user input defining a distinct role for each user within a collaborative group, wherein each role is associated with predefined preferences based on travel style (e.g., foodie, adventurer, relaxer, culture-seeker);
(b) receiving user-defined preferences associated with each role, wherein the preferences are weighted according to the user role and are dynamically adjusted based on user feedback, historical behavior, and ongoing trip data;
(c) combining the preferences from all users into a collaborative itinerary by employing a role-based preference blending engine that ensures a balanced itinerary that accommodates each user's role and individual travel style, while maintaining overall group harmony;
(d) presenting the collaborative itinerary in a shared, editable format, wherein each user can view and modify itinerary items in real-time within an interface that supports concurrent collaborative editing;
(e) tracking modifications to the itinerary and associating changes with individual users using real-time version control to ensure transparency and accountability for all group members;
(f) resolving conflicts between user preferences by employing a dynamic conflict resolution mechanism that suggests alternative itinerary items or changes based on user roles, predefined role-based priorities, and real-time user feedback, ensuring group harmony while maintaining alignment with user preferences and constraints;
(g) integrating external data sources (e.g., weather forecasts, venue availability, transit schedules) to adapt the itinerary dynamically in response to real-world conditions, ensuring that the itinerary remains feasible and current with the latest environmental or scheduling changes.

2. The method of claim 1, wherein the user roles comprise at least one of: foodie, adventurer, relaxer, culture-seeker, or wellness-focused, and the preferences comprise activity type, budget, pace, and duration of stay, wherein the preferences are hierarchically prioritized based on role.

3. The method of claim 1, further comprising the step of providing a real-time conflict resolution mechanism that detects when user preferences conflict, dynamically adjusting the itinerary and automatically suggesting modifications to reconcile the conflict, including adjustments in timing, activity replacement, or revised group priorities, ensuring that all users' needs are addressed without compromising on group goals.

4. The method of claim 1, further comprising the step of allowing users to vote on conflicting itinerary items, wherein voting is facilitated through a transparent voting mechanism, with the ability to manually adjust the itinerary based on group consensus, and re-prioritizing items based on role-based preferences or group voting results, providing an optimized itinerary that reflects democratic consensus.

5. A system for generating a multi-user collaborative travel itinerary, comprising:
(a) a user input module configured to receive user-defined roles and preferences from multiple users, wherein the roles are dynamically linked to activity preferences, budget constraints, and personalized travel styles;
(b) a preference blending engine configured to combine the preferences from all users into a collaborative itinerary, weighted according to each user's role and incorporating dynamic updates based on user feedback during the collaboration process;
(c) a collaborative editing interface configured to allow users to view and modify the itinerary in real-time, with tracking of individual contributions and notifications of conflicting changes, enabling a seamless collaborative process;
(d) a conflict resolution engine configured to detect when preferences conflict and suggest alternative itinerary items or changes based on user roles, preferences, and the availability of options, wherein the conflict resolution engine includes an intelligent adjustment module that utilizes prioritized role-based preferences to determine the best alternatives;
(e) an external data integration module configured to fetch real-time environmental data (e.g., weather, transit delays, venue availability) and use that data to adjust the itinerary as necessary, ensuring the itinerary remains feasible in real time.

6. The system of claim 5, wherein the collaborative editing interface includes real-time feedback on user modifications, tracks changes for transparency, and enables users to resolve conflicts based on a role-based prioritization algorithm.

7. The system of claim 5, further comprising a voting mechanism that allows users to vote on conflicts and provide manual adjustments to the itinerary, wherein changes are logged for transparency and to track user decisions.

8. The system of claim 5, wherein the conflict resolution engine is further configured to suggest alternative itinerary items or changes based on user feedback, preferences, and availability of options in real-time, ensuring synchronization across multiple devices and users.

9. A non-transitory computer-readable medium having stored thereon computer executable instructions, which, when executed by a processor, cause the processor to perform the steps of:
(a) receiving user-defined roles and preferences from multiple users;
(b) combining the preferences from all users into a collaborative itinerary;
(c) presenting the collaborative itinerary in a shared interface that allows multiple users to edit and modify the itinerary in real-time, ensuring synchronization across devices;
(d) resolving conflicts between user preferences and suggesting alternative modifications based on dynamic user inputs, roles, and priorities, including real-time integration with external data sources for itinerary updates.
